(19) United States
(12) Patent Application Publication
(10) Pub. No.: US 2008/0078940 A1
(43) Pub. Date: Apr. 3, 2008

(54) Portable imaging device having shock absorbent assembly

(75) Inventors: Donald Earl Castleberry, Niskayuna, NY (US); Shashishekara Sitharamarao Talya, Houston, TX (US); William Andrew Hennessy, Schenectady, NY (US)

Correspondence Address: GENERAL ELECTRIC COMPANY (PCPI);C/O FLETCHER YODER, P. O. BOX 692289, HOUSTON, TX, 77269-2289, US

(73) Assignee: General Electric Company

(21) Appl. No.: 11/542,541

(22) Filed: Oct. 3, 2006

(51) Int. Cl. G01T 1/24

(52) U.S. Cl. 250/370.09

(57) ABSTRACT

In one embodiment, a portable imaging device is provided with an enclosure, an imaging panel disposed in the enclosure, and shock absorbent material holding the imaging panel within the enclosure without a rigid connection between the imaging panel and the enclosure. In another embodiment, a portable imaging device is provided with a housing, an x-ray detector panel disposed in the housing, and shock absorbent material disposed between, and in contact with, both the housing and the x-ray detector panel, wherein the x-ray detector panel is generally free floating within the housing via the shock absorbent material.

### BACKGROUND

The invention relates generally to portable imaging devices and, more particularly, to the material and construction of a portable digital x-ray detector.

Portable imaging devices, such as portable x-ray detectors, often contain fragile components that can be highly susceptible to damage by physical impact or shock. For example, imaging devices may include silicon or glass components, such as silicon photo-detectors on a glass substrate (e.g., imaging panel). Typically, the portable imaging devices include a relatively stiff enclosure, which rigidly attaches to the internal components. For example, the enclosure may be constructed from multiple pieces of a metal, such as magnesium. Although the metal enclosure provides some degree of protection to the internal components, the enclosure is generally very heavy and susceptible to breakage due to various seams and mechanical joints in the design. Further, rigidly attaching the internal components to the enclosure allows the shock from external mechanical impacts to be transmitted to the fragile internal components. As a result, the internal components remain susceptible to damage.

### BRIEF DESCRIPTION

Certain embodiments commensurate in scope with the originally claimed invention are set forth below. It should be understood that these embodiments are presented merely to provide the reader with a brief summary of certain forms the invention might take and that these embodiments are not intended to limit the scope of the invention. Indeed, the invention may encompass a variety of features that may not be set forth below.

In accordance with a first embodiment, a portable imaging device is provided with an enclosure, an imaging panel disposed in the enclosure, and shock absorbent material holding the imaging panel within the enclosure without a rigid connection between the imaging panel and the enclosure.

In accordance with a second embodiment, a portable imaging device is provided with a housing, an x-ray detector panel disposed in the housing, and shock absorbent material disposed between, and in contact with, both the housing and the x-ray detector panel, wherein the x-ray detector panel is generally free floating within the housing via the shock absorbent material.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of a mobile x-ray imaging system using a portable digital x-ray detector;

FIG. 2 is a block diagram of an embodiment of the x-ray imaging system as illustrated in FIG. 1;

FIG. 3 is a perspective view of an embodiment of a portable flat panel digital x-ray detector;

FIG. 4 is an exploded perspective view of an embodiment of the portable flat panel digital x-ray detector as illustrated in FIG. 3, further illustrating a digital detector subsystem partially exploded from an opening in a single-piece protective enclosure; and

FIG. 5 is a cross-sectional view of an embodiment of the portable flat panel digital x-ray detector as illustrated in FIGS. 3 and 4.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In certain embodiments, as discussed below, internal components of an imaging device (e.g., digital x-ray device) are free-floating within an external enclosure, wherein a shock absorbent material is disposed between the external enclosure and the internal components (e.g., x-ray detector). In other words, the internal components are not rigidly fixed to the surrounding external enclosure, but rather the shock absorbent material holds the internal components securely within the external enclosure. Specifically, the shock absorbent material may be disposed on all sides of the internal components in direct contact with both the internal components and the external enclosure. On the top side of the internal components, a single continuous sheet of the shock absorbent material may be disposed between the internal components and the external enclosure. As discussed below, the single continuous sheet may substantially reduce or eliminate the possibility for artifacts in the detected image (e.g., x-ray image). In addition, the single continuous sheet may substantially distribute any load points on the external enclosure over a much larger area, thereby reducing the possibility for damage to the internal components. On other sides of the internal components, discrete blocks of the shock absorbent material may be arranged directly between the external enclosure and the internal components, thereby providing shock protection while enabling convective heat transfer to cool the internal components. In addition, the external enclosure may be at least mostly constructed as a single lightweight enclosure, such as a single panel shaped sleeve. For example, the external enclosure may be constructed from a graphite fiber-epoxy composite.

The portable imaging device may be used in a variety of imaging systems, such as medical imaging systems and non-medical imaging systems. For example, medical imaging systems include radiology (e.g., digital x-ray), mammography, tomosynthesis, and computed tomography (CT) imaging systems. These various imaging systems, and the different respective topologies, are used to create images or views of a patient for clinical diagnosis based on the attenuation of radiation (e.g., x-rays) passing through the patient. Alternatively, imaging systems may also be utilized in non-medical applications, such as in industrial quality control or in security screening of passenger luggage, packages, and/or cargo. In such applications, acquired data and/or generated images representing volumes or parts of volumes (e.g., slices) may be used to detect objects, shapes or irregularities which are otherwise hidden from visual inspection and which are of interest to the screener. In each of these imaging systems, the portable imaging device may include shock absorbent material to protect the internal components in a free-floating manner, thereby reducing the possibility of damage in the event of physical impact or shock (e.g., dropping the portable imaging device).

Depending on the type of imaging device, the internal components may include a variety of circuits, panels, detectors, sensors, and other relatively delicate components. X-ray imaging systems, both medical and non-medical, utilize an x-ray tube to generate the x-rays used in the imaging process. The generated x-rays pass through the imaged object where they are absorbed or attenuated based on the internal structure and composition of the object, creating a matrix or profile of x-ray beams of different strengths. The attenuated x-rays impinge upon an x-ray detector designed to convert the incident x-ray energy into a form usable in image reconstruction. Thus the x-ray profile of attenuated x-rays is sensed and recorded by the x-ray detector. X-ray detectors may be based on film-screen, computed radiography (CR) or digital radiography (DR) technologies. In film-screen detectors, the x-ray image is generated through the chemical development of the photosensitive film after x-ray exposure. In CR detectors, a storage phosphor imaging plate captures the radiographic image. The plate is then transferred to a laser image reader to “release” the latent image from the phosphor and create a digitized image. In DR detectors, a scintillating layer absorbs x-rays and subsequently generates light, which is then detected by a two-dimensional flat panel array of silicon photo-detectors. Absorption of light in the silicon photo-detectors creates electrical charge. A control system electronically reads out the electrical charge stored in the x-ray detector and uses it to generate a viewable digitized x-ray image.

In view of the various types of imaging systems and potential applications, the following discussion focuses on embodiments of a digital flat panel, solid-state, indirect detection, portable x-ray detector for use with a mobile x-ray imaging system. However, other embodiments are applicable with other types of medical and non-medical imaging devices, such as direct detection digital x-ray detectors. Additionally, other embodiments may be used with stationary or fixed room x-ray imaging systems. Further, the present application makes reference to an imaging “subject” and an imaging “object”. These terms are not mutually exclusive and, as such, use of the terms is interchangeable and is not intended to limit the scope of the appending claims.

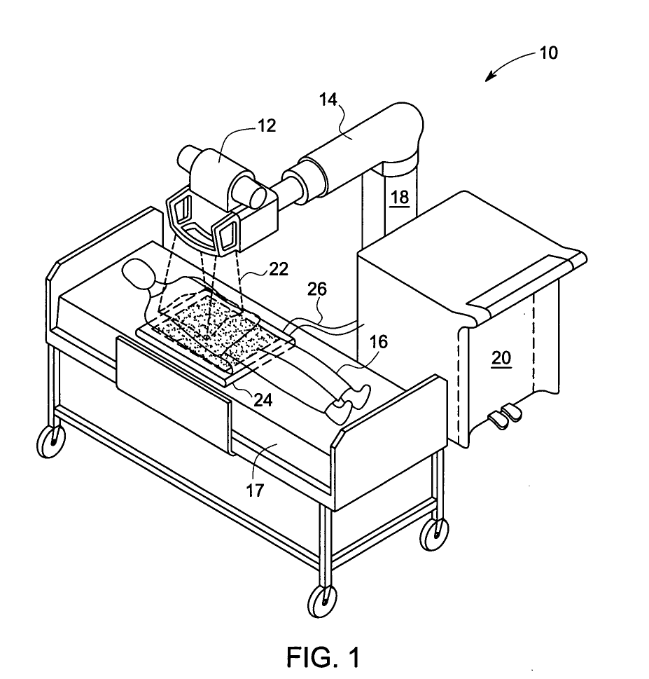

Referring now to FIG. 1, an exemplary mobile x-ray imaging system 10 employing a portable x-ray detector is illustrated. In the illustrated embodiment, the mobile x-ray imaging system 10 includes a radiation source 12, such as an x-ray source 12 mounted or otherwise secured to an end of horizontal arm 14. The arm 14 allows the x-ray source 12 to be variably positioned above a subject 16, resting on a patient table or bed 17, in such a manner so as to optimize irradiation of a particular area of interest. The x-ray source 12 may be mounted through a gimbal-type arrangement in column 18. In this regard, the x-ray source 12 may be rotated vertically from a rest or park position on the mobile x-ray unit base 20 to the appropriate position above the subject 16 to take an x-ray exposure of the subject 16. The rotational movement of column 18 may be limited to a value of 360 degrees or less to prevent entanglement of high voltage cables used to provide electrical power to the x-ray source 12. The cables may be connected to a utility line source or a battery in the base 20 to energize the x-ray source 12 and other electronic components of the system 10.

The x-ray source 12 projects a collimated cone beam of radiation 22 toward the subject 16 to be imaged. Accordingly, medical patients and luggage, packages, and the like may be non-invasively inspected using the exemplary x-ray imaging system 10. A portable x-ray detector 24 placed beneath the subject 16 acquires the attenuated radiation and generates a detector output signal. The detector output signal may then be transmitted to the mobile imaging system 10 over a wired or a wireless link 26. The system 10 may be equipped with or connectable to a display unit for the display of images captured from the imaging subject 16.

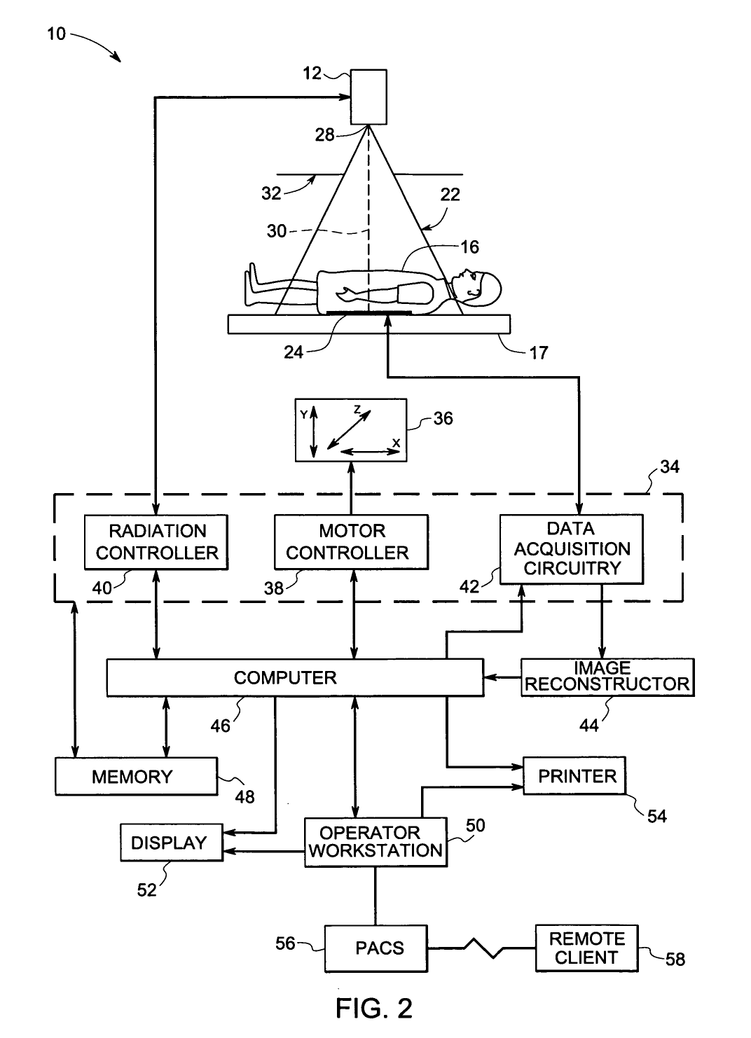

A schematic of the x-ray imaging system 10 of FIG. 1 is shown in FIG. 2. As described above, the system 10 includes the x-ray source 12 designed to project the cone beam of radiation 22 from focal spot 28 along axis 30 toward the subject 16 to be imaged. The radiation 22 passes through the subject 16, which provides the attenuation, and resulting attenuated portion of the radiation impacts the detector array 24. It should be noted that portions of the x-ray beam 22 may extend beyond the boundary of the patient 16 and may impact detector array 24 without being attenuated by the patient 16. In the embodiments discussed herein, a flat panel digital detector may be employed to detect the intensity of radiation 22 transmitted through or around the subject 16 and to generate a detector output signal in response to the detected radiation. A collimator 32 may be positioned adjacent to the x-ray source 12. The collimator typically defines the size and shape of the x-ray cone beam 22 that passes into a region in which a subject 16, such as a human patient, is positioned and may therefore control the scope of irradiation.

The digital detector 24 is generally formed by a plurality of detector elements, which detect the x-rays 22 that pass through or around the subject 16. For example, the detector 24 may include multiple rows and/or columns of detector elements arranged in a two-dimensional array. Each detector element, when impacted by an x-ray flux, produces an electrical signal proportional to the absorbed x-ray flux at the position of the individual detector element in detector 24. These signals are acquired and processed to reconstruct an image of the features within the subject, as described below.

The radiation source 12 is controlled by a system controller 34, which furnishes power, focal spot location, control signals and so forth for imaging sequences. Moreover, the detector 24 is coupled to the system controller 34, which controls the acquisition of the signals generated in the detector 24. The system controller 34 may also execute various signal processing and filtration functions, such as for initial adjustment of dynamic ranges, interleaving of digital image data, and so forth. In general, system controller 34 commands operation of the imaging system 10 to execute examination protocols and to process acquired data. In the present context, system controller 34 may also include signal processing circuitry, typically based upon a general purpose or application-specific digital computer, and associated memory circuitry. The associated memory circuitry may store programs and routines executed by the computer, configuration parameters, image data, and so forth. For example, the associated memory circuitry may store programs or routines for reconstructing image from the detector output signal.

In the embodiment illustrated in FIG. 2, the system controller 34 may control the movement of a motion subsystem 36 via a motor controller 38. In the depicted imaging system 10, the motion subsystem 36 may move the x-ray source 12, the collimator 32, and/or the detector 24 in one or more directions in space with respect to the patient 16. It should be noted that the motion subsystem 36 might include a support structure, such as a C-arm or other movable arm, on which the source 12 and/or the detector 24 may be disposed. The motion subsystem 36 may further enable the patient 16, or more specifically the patient table 17, to be displaced with respect to the source 12 and the detector 24 to generate images of particular areas of the patient 16.

The source 12 of radiation may be controlled by a radiation controller 40 disposed within the system controller 34. The radiation controller 40 may be configured to provide power and timing signals to the radiation source 12. In addition, the radiation controller 40 may be configured to provide focal spot location, for example, emission point activation, if the source 12 is a distributed source having discrete electron emitters.

Further, the system controller 34 may include data acquisition circuitry 42. In this exemplary embodiment, the detector 24 is coupled to the system controller 34, and more particularly to the data acquisition circuitry 42. The data acquisition circuitry 42 receives data collected by readout electronics of the detector 24. The analog to digital conversion may be performed in the detector readout electronics 76 discussed below.

The computer or processor 46 is typically coupled to the system controller 34 and may include a microprocessor, digital signal processor, microcontroller, and other devices designed to carry out logic and processing operations. The data collected by the data acquisition circuitry 42 may be transmitted to the image reconstructor 44 and/or the computer 46 for subsequent processing and reconstruction. For example, the data collected from the detector 24 may undergo pre-processing and calibration at the data acquisition circuitry 42, the image reconstructor 44, and/or the computer 46 to condition the data to represent the line integrals of the attenuation coefficients of the scanned objects. The processed data may then be reordered, filtered, and backprojected to formulate an image of the scanned area. Although a typical filtered back-projection reconstruction algorithm is described in the present aspect, it should be noted that any suitable reconstruction algorithm may be employed, including statistical reconstruction approaches. Once reconstructed, the image produced by the imaging system 10 reveals an internal region of interest of the patient 16 which may be used for diagnosis, evaluation, and so forth.

The computer 46 may include or communicate with memory 48 that can store data processed by the computer 46 or data to be processed by the computer 46. It should be understood that any type of computer accessible memory device capable of storing the desired amount of data and/or code may be utilized by such an exemplary system 10. Moreover, the memory 48 may include one or more memory devices, such as magnetic or optical devices, of similar or different types, which may be local and/or remote to the system 10. The memory 48 may store data, processing parameters, and/or computer programs including one or more routines for performing the reconstruction processes. Furthermore, memory 48 may be coupled directly to system controller 34 to facilitate the storage of acquired data.

The computer 46 may also be adapted to control features enabled by the system controller 34, e.g., scanning operations and data acquisition. Furthermore, the computer 46 may be configured to receive commands and scanning parameters from an operator via an operator workstation 50 which may be equipped with a keyboard and/or other input devices. An operator may thereby control the system 10 via the operator workstation 50. Thus, the operator may observe the reconstructed image and other data relevant to the system from operator workstation 50, initiate imaging, and so forth.

A display 52 coupled to the operator workstation 50 may be utilized to observe the reconstructed image. Additionally, the scanned image may be printed by a printer 54 coupled to the operator workstation 50. The display 52 and the printer 54 may also be connected to the computer 46, either directly or via the operator workstation 50. Further, the operator workstation 50 may also be coupled to a picture archiving and communications system (PACS) 56. It should be noted that PACS 56 might be coupled to a remote system 58, such as a radiology department information system (RIS), hospital information system (HIS) or to an internal or external network, so that others at different locations may gain access to the image data.

One or more operator workstations 50 may be linked in the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, virtual private networks, and so forth.

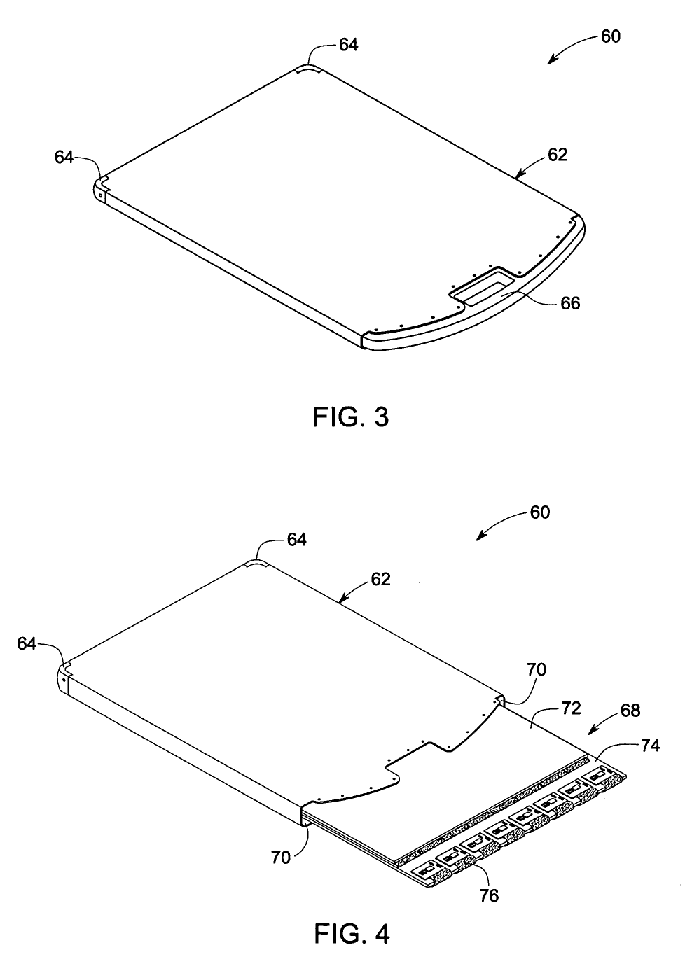

The exemplary imaging system 10, and other imaging systems based on radiation detection, employs a detector 24, such as a flat panel, digital x-ray detector. A perspective view of such an exemplary flat panel, digital x-ray detector 60 is provided in FIG. 3. However, as mentioned above, other embodiments of the detector 60 may include other imaging modalities in both medical and non-medical applications. The exemplary flat panel, digital x-ray detector 60 includes a detector subsystem for generating electrical signals in response to reception of incident x-rays. In accordance with certain embodiments, a single-piece protective housing 62 provides an external enclosure to the detector subsystem, so as to protect the fragile detector components from damage when exposed to an external load or an impact. In addition, as discussed in further detail below, the detector 60 includes shock absorbent material to protect the internal components in a free-floating manner within the single-piece protective housing 62. In general, the single-piece protective enclosure 62 may be a continuous structure and may be substantially devoid of any discontinuities. In one embodiment, the single-piece protective enclosure may be a 4-5 sided structure in a sleeve like configuration having at least one opening to allow for the insertion of the detector subsystem. It should be noted that the individual sides or edges of the single-piece sleeve may be flat, rounded, curved, contoured, or shaped to improve detector ruggedness and ease of use. The single-piece protective enclosure 62 may be formed of materials such as a metal, a metal alloy, a plastic, a composite material, or a combination of the above. In the certain embodiments, the material has low x-ray attenuation characteristics. In one embodiment, the protective enclosure 62 may be formed of a lightweight, durable composite material such as a carbon fiber reinforced plastic material or a graphite fiber-epoxy composite. Additionally, the single-piece protective enclosure 62 may be designed to be substantially rigid with minimal deflection when subjected to an external load.

One or more corner or edge caps 64 may be provided at respective corners, edges, or a portion of respective edges of the single-piece protective enclosure 62. It should be noted that the one or more corner or edge caps 64 may be formed of an impact resistant, energy absorbent material such as nylon, polyethylene, ultra high molecular weight polyethylene (UHMW-PE), delrin, or polycarbonate. UHMW polyethylene is a linear polymer with a molecular weight in the range of 3,100,000 to 6,000,000. Further, a handle 66 may be mechanically coupled to the single-piece protective enclosure 62 to facilitate the portability of the detector 60. This handle may be a separate component, which is attached to the single-piece protective enclosure 62. Again, it should be noted that the handle 66 may be formed of an impact resistant, energy absorbent material such as a high molecular weight polyethylene. Alternatively, in certain embodiments, the handle 66 may be a continuous extension of the single-piece protective enclosure 62. In other words, the handle 66 may be formed integrally with the single-piece protective enclosure, thereby eliminating or minimizing the mechanical attachment points between the handle 66 and the protective enclosure 62. A removable edge cap may be provided in such embodiments to allow for the insertion of the detector subsystem into the single-piece protective enclosure 62.

As shown, the detector 24 may be constructed without a fixed tether. Alternatively, the detector may be connected to a tether that is used to connect the detector readout electronics to the data acquisition system of the scanner when in use. When not in use, the detector may be easily detached from tether and stored remotely from the imaging system. As such, detector may be transported to and from multiple scan stations remote from one another. This is particularly advantageous for emergency rooms and other triage facilities. The portability and detachability of the detector further enhances the mobility of a mobile x-ray imaging system, such as that shown in FIG. 1.

FIG. 4 illustrates the detector subsystem 68 of the portable flat panel digital x-ray detector 60 disposed within the single-piece protective enclosure 62 through an opening 70. Again, as mentioned above, the internal components (e.g., subsystem 68) may include a variety of imaging components, such as radiography (e.g., digital x-ray), computed tomography, mammography, and so forth. The illustrated detector subsystem 68 includes an imaging panel 72, a panel support 74, and associated read-out electronics 76. The imaging panel 72 includes a scintillator layer for converting incident x-rays to visible light. The scintillator layer, which may be fabricated from Cesium Iodide (CsI) or other scintillating materials, is designed to emit light proportional to the energy and the amount of the x-rays absorbed. As such, light emissions will be higher in those regions of the scintillator layer where either more x-rays were received or the energy level of the received x-rays was higher. Since the composition of the subject will attenuate the x-rays projected by the x-ray source to varying degrees, the energy level and the amount of the x-rays impinging upon the scintillator layer will not be uniform across the scintillator layer. This variation in light emission will be used to generate contrast in the reconstructed image.

The light emitted by the scintillator layer is detected by a photosensitive layer on the 2D flat panel substrate. The photosensitive layer includes an array of photosensitive elements or detector elements to store electrical charge in proportion to the quantity of incident light absorbed by each detector elements. Generally, each detector element has a light sensitive region and a region including electronics to control the storage and output of electrical charge from that detector element. The light sensitive region may be composed of a photodiode, which absorbs light and subsequently creates and stores electronic charge. After exposure, the electrical charge in each detector element is read out using logic-controlled electronics 76.

Each detector element may be controlled using a transistor-based switch. In this regard, the source of the transistor is connected to the photodiode, the drain of the transistor is connected to a readout line, and the gate of the transistor is connected to a scan control interface disposed on the electronics 76 in the detector 60. When negative voltage is applied to the gate, the switch is driven to an OFF state, thereby preventing conduction between the source and the drain. Conversely, when a positive voltage is applied to the gate, the switch is turned ON, thereby allowing charge stored in the photodiode to pass from the source to the drain and onto the readout line. Each detector element of the detector array is constructed with a respective transistor and is controlled in a manner consistent with that described below.

Specifically, during exposure to x-rays, negative voltage is applied to all gate lines resulting in all the transistor switches being driven to or placed in an OFF state. As a result, any charge accumulated during exposure is stored in the photodiode of each detector element. During read out, positive voltage is sequentially applied to each gate line, one gate line at a time. That is, the detector is an X-Y matrix of detector elements and all of the gates of the transistors in a line are connected together so that turning ON one gate line simultaneously reads out all the detector elements in that line. In this regard, only one detector line is read out at a time. A multiplexer may also be used to support read out of the detector elements in a raster fashion. An advantage of sequentially reading out each detector element individually is that the charge from one detector element does not pass through any other detector elements. The output of each detector element is then input to an output circuit (e.g., a digitizer) that digitizes the acquired signals for subsequent image reconstruction on a per pixel basis. Each pixel of the reconstructed image corresponds to a single detector element of the detector array.

The imaging panel 72 is supported by a thin and lightweight panel support 74. The readout electronics and other electronics 76 are disposed on the panel support 74 on the side opposite from the imaging panel 72. That is, the panel support 74 mechanically isolates the imaging components of the imaging panel 72 from the readout electronics 76.

Generally, the panel support 74 may be formed of a metal, a metal alloy, a plastic, a composite material, or a combination of the above material. In one embodiment, the panel support 74 may be substantially formed of a carbon fiber reinforced plastic material or a graphite fiber-epoxy composite. In another embodiment, the panel support 74 may be substantially formed of composite materials in combination with a foam core in a laminated sandwich construction so as to provide a lightweight yet stiff assembly to serve as the panel support. The construction of panel support 74 from the composite materials alone or composite materials in combination with foam cores reduces weight while providing greater mechanical stiffness and improved energy absorption capability. For example, one embodiment of the panel support 74 includes a graphite fiber-epoxy composite with a foam core.

The composite materials are typically combinations of a reinforcement and a matrix. The matrix material, such as a resin or epoxy, surrounds and supports the reinforcement material. The reinforcement materials, such as an organic or inorganic fibers or particles, are bound together by the composite matrix. For fiber reinforcements, the direction the individual fibers may be oriented to control the rigidity and the strength of the composite. Further, the composite may be formed of several individual layers with the orientation or alignment of the reinforcement layers varying through the thickness of composite. The construction may be a laminate type construction (containing layers of reinforcements only) or a sandwich type construction (where a soft core is inserted between two sets of reinforcement layers). The resins used could be thermosets or thermoplastics. In sandwich type construction, the soft core can result in additional weight reduction and could have metal or non-metallic pins to enhance the energy absorption capability. Also, the layers of the composite could use multiple materials (Carbon, Kevlar, Aluminum foil etc.) in different forms (particles, fibers, fabric, thin foils etc.). In one embodiment, the composite material for the portable x-ray detector 60 may be configured from carbon fibers or epoxy resins in a layered construction with a foam core.

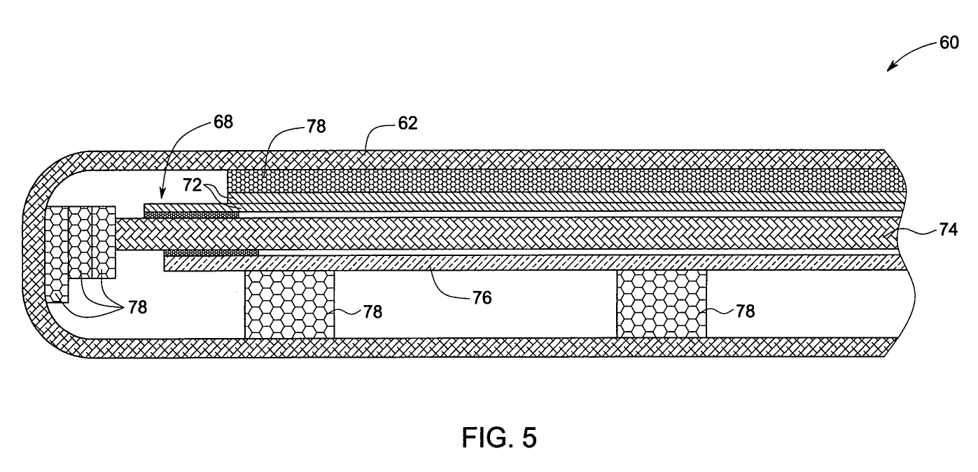

Turning now to the interior, FIG. 5 is a cross-sectional view of an embodiment of the portable flat panel digital x-ray detector 60, further illustrating impact resistant or shock absorbent material 78 disposed about all sides of the internal components (e.g., detector subsystem 68) within the external protective enclosure 62. In this manner, the detector subsystem 68 may be described as free-floating within the external protective enclosure 62 via the shock absorbent material 78. In other words, the detector subsystem 68 is not rigidly fixed to the external protective enclosure 62, but rather the detector subsystem 68 has at least some freedom to move in all directions within the enclosure 62 via the shock absorbent material 78. This freedom may be varied depending on the degree of compressibility of the shock absorbent material 78. In certain embodiments, the shock absorbent material 78 may include a rubber, a foam, an elastomer, a foam rubber, another elastic material, or a combination thereof. For example, the shock absorbent material 78 may include fine-celled, low compression-set, high density polyurethane foams and/or a high density, flexible, microcellular urethane foam materials. Although these foams are described as high density, the shock absorbent material 78 is generally low density as compared with other materials. In some embodiments, the shock absorbent material 78 may include CONFOR foam and/or ISOLOSS foam manufactured by E-A-R Specialty Composites, a business unit of Aearo Technologies, Indianapolis, Ind. In other embodiments, the shock absorbent material 78 may include PORON foam manufactured by Rogers Corporation, Rogers, Conn. The shock absorbent material 78 generally has a high impact resistance or energy-absorption characteristic, such as 50, 60, 70, 80, or 90 percent absorption of an impact. In some embodiments, the energy-absorption of the shock absorbent material 78 may be about 95, 96, 97, 98, or 99 percent of an impact. These foams are also generally lightweight, and may include single-sided or double-sided adhesive surfaces to facilitate the attachment to the external protective enclosure 62 and/or the detector subsystem 68.

In certain embodiments, one or more pieces of the shock absorbent material 78 may be disposed between the detector subsystem 68 and the inner surface of the single-piece protective enclosure 62 to hold the detector subsystem 68. For example, one or more layers, strips, blocks, sheets, or panels of the shock absorbent material 78 may be disposed on all six sides (e.g., top, bottom, left, right, front, and rear) of the detector subsystem 68 within the protective enclosure 62. In certain embodiments, the shock absorbent material 78 may include multiple layers of different materials, different geometries (e.g., rectangular, circular, triangular, etc.), different dimensions (e.g., length, width, thickness, etc.), or combinations thereof. These pieces of shock absorbent material are generally in contact with both the detector subsystem 68 and the protective enclosure 62 without any gap. In this manner, the pieces of shock absorbent material 78 act both as positional supports and shock absorbers for the detector subsystem 68. Again, the detector subsystem 68 may be described as suspended or free floating within the single-piece protective enclosure 62 via the shock absorbent material, rather than being rigidly attached to the external protective enclosure 62.

Additionally, the single piece protective enclosure 62 may be constructed with bumpers, foam inserts, layers of shock absorbent material, and the like to inhibit fracturing of the detector components 68 when dropped or subjected to a load. As described above, the x-ray detector 60 is designed to withstand relatively high-energy impacts, stresses, and strains such that the relatively sensitive components 68, such as imaging panel and associated electronics, are not damaged when the detector 60 is dropped or subjected to external load. In one embodiment, the x-ray detector 60 includes two layers of shock absorbent material 78 sealed against or otherwise placed under the top and bottom surfaces of the single piece protective enclosure 62. Further, the detector 60 may include multiple layers of shock absorbent materials 78 interstitially disposed between the detector components 68.

It should be noted that the shock absorbent material 78 is designed not to attenuate radiation so as not to interfere with data acquisition. The shock absorbent material 78 is an elastic material configured to absorb the shock and vibrations placed on the detector 60 when dropped and to deflect the force placed on the detector 60 when stepped upon or otherwise subjected to a load, e.g. patient weight. The elastic material may be rubber, foam, foam rubber, or other plastic and is designed to deflect and absorb stresses and strains on the detector 60. As such, when the detector 60 is stepped upon or dropped, the internal components (e.g., subsystem 68) of the detector 60 do not fracture or become damaged. The thickness, density, and composition of the shock absorbent material 78 may be variably selected to define the limits by which the detector 60 may be subjected to a load or dropped without damage to the detector components 68.

Further, the two shock absorbent layers may have similar or dissimilar thicknesses, and may be composed of similar or dissimilar shock absorbent material 78. For example, the top layer may be designed to be more absorbent and deflective than the bottom layer and may therefore be thicker than the bottom layer or may be formed from material with improved absorption and deflective characteristics. In one embodiment, the top layer may be formed of foam having pronounced elastic properties whereas the bottom layer may be formed of polyurethane, PVC, or other material with less pronounced elastic characteristics.

The portable x-ray detector 60 described in various embodiments discussed above is lightweight yet mechanically stiff and rugged and has improved energy absorption capability. The structural load bearing components (the protective enclosure 62 and the panel support 74) of the portable x-ray detector 60 are made up of a composite material. The composite material offers high mechanical rigidity and strength while simultaneously making the construction lightweight. The low density of the composite material used helps reduce the weight while the high modulus and strength of the carbon fiber composite helps to make the construction rigid and strong.

The sleeve design (open on at least one end for insertion of detector subsystem 68) of the protective enclosure 62 provides mechanical ruggedness since fasteners are no longer required to hold the faces and sides of the external enclosure together. Additionally, the design allows for the fabrication with either composites or plastics and therefore reduces weight and improves mechanical toughness. The single-piece design of the external enclosure 62 is more rugged since multi-piece assembly can fail during mechanical impact. Moreover, the use of thermoplastic based epoxy or rubber toughened epoxy in composite construction improves energy absorption.

Further, the new packaging design for the portable x-ray detector 60, described in various embodiments discussed above, isolates the fragile detector subsystem 68 (imaging panel and readout electronics) from the external protective enclosure 62 by employing shock absorbent material 78 (e.g., foam pieces) on all sides. Isolating of the detector subsystem 68 from the external protective enclosure 62 protects the detector subsystem 68 from external shock and stresses occurring as a result of being dropped or banged against hard objects accidentally.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A portable imaging device, comprising:
an enclosure;
an imaging panel disposed in the enclosure; and
shock absorbent material holding the imaging panel within the enclosure without a rigid connection between the imaging panel and the enclosure.

2. The portable imaging device of claim 1, wherein the enclosure comprises a portable non-metallic enclosure.

3. The portable imaging device of claim 1, wherein the enclosure comprises a graphite fiber epoxy composite.

4. The portable imaging device of claim 1, wherein the enclosure comprises an inner wall, an outer wall, and a foam core disposed between the inner and outer walls.

5. The portable imaging device of claim 1, wherein the imaging panel comprises an x-ray detector panel.

6. The portable imaging device of claim 1, wherein the shock absorbent material is disposed in contact with both the imaging panel and the enclosure on multiple sides of the imaging panel.

7. The portable imaging device of claim 1, wherein the imaging panel is generally free floating within the enclosure via the shock absorbent material.

8. The portable imaging device of claim 1, wherein the shock absorbent material comprises multiple layers of different shock absorbent materials.

9. The portable imaging device of claim 1, wherein the shock absorbent material has a generally low x-ray attenuation characteristic.

10. The portable imaging device of claim 1, comprising a continuous uniform sheet of the shock absorbent material between a top side of the imaging panel and the enclosure.

11. The portable imaging device of claim 1, wherein the imaging panel is disposed on a panel support, and the panel support comprises another shock absorbent material.

12. The portable imaging device of claim 1, wherein the shock absorbent material comprises foam.

13. A portable imaging device, comprising:
a housing;
an x-ray detector panel disposed in the housing; and
shock absorbent material disposed between, and in contact with, both the housing and the x-ray detector panel, wherein the x-ray detector panel is generally free floating within the housing via the shock absorbent material.

14. The portable imaging device of claim 13, wherein the enclosure comprises a fiber reinforced material.

15. The portable imaging device of claim 13, wherein the enclosure comprises a double walled structure having a shock absorbent core.

16. The portable imaging device of claim 13, wherein the shock absorbent material is disposed on all six sides of the x-ray detector panel.

17. The portable imaging device of claim 13, wherein the shock absorbent material comprises a fine-celled, low compression-set, low density material.

18. The portable imaging device of claim 13, wherein the x-ray detector panel is disposed on a panel support, and the panel support comprises another shock absorbent material.

19. A method, comprising:
absorbing shock on all sides of an imaging panel disposed within a portable housing.

20. The method of claim 19, wherein absorbing shock comprises absorbing energy of an impact into a shock absorbent material holding the imaging panel in a free floating manner within the portable housing.

21. The method of claim 19, comprising detecting x-rays through a continuous uniform sheet of shock absorbent material disposed between a top of the imaging panel and the portable housing.

22. A method, comprising:
mounting an imaging panel within a portable housing in a free floating manner via shock absorbent material.

23. The method of claim 22, wherein mounting comprises fitting the shock absorbent material between the portable housing and the imaging panel on at least a top, a bottom, and two or more sides of the imaging panel.
